(19) United States
(12) Patent Application Publication
(10) Pub. No.: US 2026/0350689 A1
(43) Pub. Date: Nov. 5, 2026

(54) GAME PRODUCT TRANSACTION METHOD, APPARATUS AND SYSTEM, AND ELECTRONIC DEVICE AND STORAGE MEDIUM

(71) Applicant: NETEASE (HANGZHOU) NETWORK CO., LTD., Hangzhou (CN)

(72) Inventors: Yimin Tu, Hangzhou (CN); Guiliang LU, Hangzhou (CN); Liebing CHEN, Hangzhou (CN)

(21) Appl. No.: 19/123,026

(22) PCT Filed: Apr. 3, 2023
(86) PCT No.: PCT/CN2023/086037

§ 371 Date: Apr. 21, 2025

(30) Foreign Application Priority Data
Oct. 21, 2022 (CN) 202211295078.1

(51) Int. Cl. G06Q 30/0601; G06Q 30/018

(52) U.S. Cl. CPC G06Q 30/06313; G06Q 30/018

(57) ABSTRACT

The present disclosure provides a game product transaction method. The method includes displaying a product transaction system page of a target game, where the product transaction system page includes a product identifier of a transaction-available product; generating a product purchase request in response to a purchase operation for a target product; sending the product purchase request to a server, the server being configured to, in response to the product purchase request, select an alternative product for transaction when the target product is in a transaction-unavailable state and send transaction event information of the alternative product; receiving the transaction event information of the alternative product, and display the transaction event information in the product transaction system page.

The present disclosure is a 371 national phase application of PCT Application No. PCT/CN2023/086037 filed Apr. 3, 2023, which claims priority to Chinese patent application No. 202211295078.1 filed to the China National Intellectual Property Administration on Oct. 21, 2022 and entitled “GAME PRODUCT TRANSACTION METHOD, APPARATUS, AND SYSTEM, AND ELECTRONIC DEVICE AND STORAGE MEDIUM”, the entire contents of both applications are hereby incorporated by reference for all purposes.

### TECHNICAL FIELD

The present disclosure relates to the technical field of Internet, and particularly relates to a game product transaction method, apparatus and system, and an electronic device and a storage medium.

### BACKGROUND

With the rapid development of the game industry, more and more people are interacting with other game users through games, enjoying the audio and video content in the games, and relaxing their bodies and minds. Currently, game users can trade game props and the like products with other users in a game through virtual property such as virtual game currency or virtual game products.

### SUMMARY

The present disclosure provide a game product transaction method, apparatus and system, and an electronic device and a storage medium, which can improve the efficiency of product transaction conducted by a user and reduce the background load of a game application when the game user wants to conduct transaction in a game.

According to a first aspect, the present disclosure provides a game product transaction method, including: displaying a product transaction system page of a target game, where the product transaction system page includes a product identifier of a product available for transaction; generating a product purchase request in response to a purchase operation for a target product; sending the product purchase request to a server, the server being configured to, in response to the product purchase request, select an alternative product for transaction when the target product is in a transaction-unavailable state and send transaction event information of the alternative product; and receiving the transaction event information of the alternative product and displaying the transaction event information in the product transaction system page.

According to a second aspect, the present disclosure further provides a game product transaction method, including receiving a product purchase request triggered by a product transaction system page of a target game, where the product purchase request includes target identification information of a target product intended for purchase via operation of the client; acquiring the target identification information from the product purchase request, and performing transaction validity verification on the target product based on the target identification information to determine whether the target product is in a transaction-available state in a product transaction system; acquiring target attribute information of the target product when the target product is not in a transaction-available state; selecting, based on the target attribute information, an alternative product from products in a transaction-available state in the product transaction system, the alternative product meeting a purchase intention corresponding to the product purchase request; and performing a transaction with the client based on the alternative product.

According to a third aspect, the present disclosure further provides a game product transaction method, including: displaying, by a client of a target game, a product transaction system page, where the product transaction system page includes a product identifier of a product available for transaction; generating, by the client, a product purchase request in response to a purchase operation for a target product, and sending the product purchase request to a server of the target game, where the product purchase request includes target identification information of the target product intended for purchase via operation of the client; receiving, by the server, the product purchase request, acquiring the target identification information from the product purchase request, and performing transaction validity verification on the target product based on the target identification information to determine whether the target product is in a transaction-available state in the product transaction system; acquiring, by the server, target attribute information of the target product when the target product is not in a transaction-available state, and selecting, based on the target attribute information, an alternative product from products in a transaction-available state in the product transaction system, the alternative product satisfying a purchase intention corresponding to the purchase request; performing, by the server, a transaction with the client based on the alternative product, and sending transaction event information of the alternative product to the client; and receiving, by the client, the transaction event information of the alternative product, and displaying the transaction event information in the product transaction system page.

According to a fourth aspect, the present disclosure further provides a system including one or more memory collectively containing one or more programs, and one or more processors, where the one or more processors are configured to, individually or collectively, perform the operations of one or more steps of one of the above-mentioned game product transaction methods.

According to a fifth aspect, the present disclosure further provides one or more non-transitory computer-readable storage media containing, in any combination, computer program code that, when executed by a computer system, perform operations of one or more steps of one of the above-mentioned game product transaction methods.

### BRIEF DESCRIPTION OF DRAWINGS

In order to describe the technical solutions in the embodiments of the present disclosure more clearly, the following briefly describes the accompanying drawings required for describing the embodiments. Apparently, the accompanying drawings in the following description are only some embodiments of the present disclosure, and those of skills in the art may still derive other accompanying drawings from these accompanying drawings without creative efforts.

FIG. 1 is a schematic diagram of a scenario of a game product transaction method provided in one of embodiments of the present disclosure;

FIG. 2 is a flowchart of a game product transaction method provided in one of the embodiments of the present disclosure;

FIG. 3 is a flowchart of another game product transaction method provided in one of the embodiments of the present disclosure;

FIG. 4 is a schematic diagram of a game product transaction process provided in one of embodiments of the present disclosure;

FIG. 5 is a flowchart of a further game product transaction method provided in one of the embodiments of the present disclosure;

FIG. 6 is another flowchart of a game product transaction method provided in one of the embodiments of the present disclosure;

FIG. 7 is a schematic structural diagram of a game product transaction apparatus provided in one of the embodiments of the present disclosure;

FIG. 8 is a schematic structural diagram of another game product transaction apparatus provided in one of embodiments of the present disclosure;

FIG. 9 is a schematic structural diagram of another game product transaction apparatus provided in one of embodiments of the present disclosure; and

FIG. 10 is a schematic structural diagram of an electronic device provided in one of embodiments of the present disclosure.

### DETAILED DESCRIPTION

The following clearly and completely describes the technical solutions in the embodiments of the present disclosure with reference to the accompanying drawings in the examples of the present disclosure. Apparently, the described examples are merely a part rather than all of the embodiments of the present disclosure. All other embodiments obtained by those skilled in the art based on the embodiments of the present disclosure without creative efforts are within the claimed scope of the present disclosure.

Embodiments of the present disclosure provide a game product transaction method and apparatus, an electronic device, and a computer-readable storage medium. Specifically, the embodiments of the present disclosure provide a game product transaction method applicable to a game product transaction apparatus, and the game product transaction apparatus can be integrated in an electronic device.

The electronic device may include terminals on the client side and the like devices, including but not limited to mobile terminals and fixed terminals. For example, mobile terminals include but are not limited to smart phones, smart watches, tablet computers, laptops, smart vehicle-mounted terminals, etc., among which the fixed terminals include but are not limited to desktop computers, smart TVs, etc.

The electronic device may further include a server and the like devices. The server may be a standalone physical server, or may be a server cluster or a distributed system composed of a plurality of physical servers, or may be a cloud server providing basic cloud computing service, such as cloud service, cloud database, cloud computing, cloud function, cloud storage, network service, cloud communication, middleware service, domain name service, security service, a Content Delivery Network (CDN), big data, and an artificial intelligence platform, but is not limited to this.

The game product transaction method of the embodiments of the present disclosure may be implemented by a terminal or a server, or may be implemented by a terminal and a server together.

Reference will now be described in detail to examples, which are illustrated in the accompanying drawings. The following description refers to the accompanying drawings in which the same numbers in different drawings represent the same or similar elements unless otherwise represented. The examples described following do not represent all examples consistent with the present disclosure. Instead, they are merely examples of devices and methods consistent with aspects of the disclosure as detailed in the appended claims.

Terms used in the present disclosure are merely for describing specific examples and are not intended to limit the present disclosure. The singular forms “one”, “the”, and “this” used in the present disclosure and the appended claims are also intended to include a multiple form, unless other meanings are clearly represented in the context. It should also be understood that the term “and/or” used in the present disclosure refers to any or all of possible combinations including one or more associated listed items.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

It should be understood that although terms “first”, “second”, “third”, and the like are used in the present disclosure to describe various information, the information is not limited to the terms. These terms are merely used to differentiate information of a same type. For example, without departing from the scope of the present disclosure, first information is also referred to as second information, and similarly the second information is also referred to as the first information. Depending on the context, for example, the term “if” used herein may be explained as “when” or “while”, or “in response to . . . , it is determined that”.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

A unit or module may be implemented purely by software, purely by hardware, or by a combination of hardware and software. In a pure software implementation, for example, the unit or module may include functionally related code blocks or software components, that are directly or indirectly linked together, so as to perform a particular function.

Since there is a certain network delay in updating transaction-related information such as product information in a game, it may happen during a transaction that a product selected and purchased by a game user through a client of the game may appear to be still available for transaction to the game user, but in fact the product has been removed from the shelf. At this time, the transaction initiated by the game user will be judged as failed, and the game user will need to re-select the product for transaction. This game product transaction manner, which requires the game user to initiate transactions multiple times, will affect the transaction efficiency of the game user and increase the background load of game applications.

By adopting the solution as provided in the present disclosure, the product transaction system page of the target game can be displayed. The product transaction system page includes a product identifier of at least one transaction-available product. A product purchase request is generated in response to the purchase operation for the target product, and the product purchase request is sent to the server, to trigger the server to respond to the product purchase request, select an alternative product for transaction when the target product is in a transaction-unavailable state, and sends transaction event information of the alternative product, receives the transaction event information of the alternative product, and displays the transaction event information in the product transaction system page. Since in the embodiment of the present disclosure, when the target product that a user wants to purchase is not in a transaction-available state, an alternative product can be selected for transaction with the user, the effect of product information asynchrony caused by network delays and the like reasons is avoided, reducing the frequency of transaction failures of the game user, and reducing the number of requests from the game user for refreshing the product transaction system page and re-selecting a new product from the product transaction system page for transaction, which can improve the efficiency of product transaction performed by the game user and reduce the background load of game applications.

The following takes the game product transaction method implemented by a client and a server together as an example to illustrate the method.

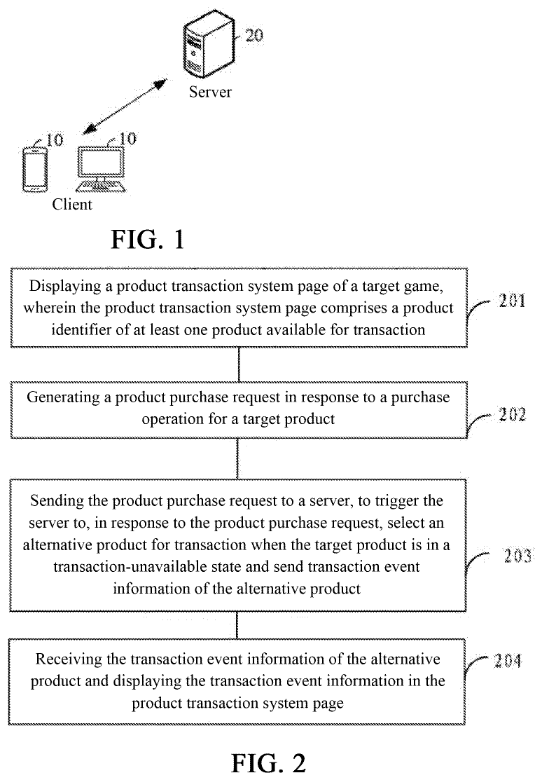

As shown in FIG. 1, a game product transaction system provided by the embodiments of the present disclosure includes a client 10 and a server 20, etc. The client 10 and the server 20 are connected via a network, for example connected via a wired or wireless network, etc., where the client 10 can exist as a client that can run a target game.

The client 10 can be used for displaying a product transaction system page of the target game, and the product transaction system page includes a product identifier of at least one product available for transaction. The client 10 can generate a product purchase request in response to a purchase operation for a target product, and send the product purchase request to the server 20.

The server 20 can respond to the product purchase request, select an alternative product for transaction when the target product is in a transaction-unavailable state, and send transaction event information of the alternative product to the client 10.

The client 10 can receive the transaction event information of the alternative product, and displays the transaction event information in the product transaction system page.

The detailed description will be provided hereafter respectively. It should be noted that the order of description of the embodiments hereafter does not impose any limitation on a preferred order of the embodiments.

The embodiments of the present disclosure will be described from the perspective of a game product transaction apparatus, which may be specifically integrated in a client.

As shown in FIG. 2, a specific flow of the game product transaction method of this embodiment may be as follows.
201. a product transaction system page of a target game is displayed, where the product transaction system page includes a product identifier of at least one product available for transaction.

In the embodiment of the present disclosure, the target game is a game-type application program that provides a product transaction function. it can be understood that, the product transaction function is just one function in the target game. The target game may be a role-playing game, an action game, an adventure game, a racing game, etc., which is not limited in the embodiments of the present disclosure.

The product transaction system page is a display page of the product transaction system provided in the target game. A game user of the target game can perform transaction through the product transaction system in the client, such as exchanging his/her own props with props of other game users, purchasing props of other game users with virtual currency, etc. In some embodiments, the game user may also sell his/her own props and the like resources through the product transaction system.

Specifically, the product identifier may be the product name, product price, etc. of a product available for transaction.
202. a product purchase request is generated in response to a purchase operation for a target product.

Specifically, the product purchase request may be generated by the client of the target game in response to a trigger operation in the product transaction system page. The client can send the product purchase request to the server of the target game for processing.

The target product is a product that the game user determines to purchase in the product transaction system by operating the client. The purchase intention of the game user can be obtained based on the triggering operation of the game user in the product transaction system page. For example, the game user may perform a purchase operation for a certain product in the product transaction system page of the client, and at this time, the product may be considered as the target product.
203. the product purchase request is sent to a server, to trigger the server to, in response to the product purchase request, select an alternative product for transaction when the target product is in a transaction-unavailable state and send transaction event information of the alternative product.

Products that have been subjected to transaction through the product transaction system, products that have not been subjected to transaction in the product transaction system but have been removed from the shelves by the game user himself or herself, products that have not been subjected to transaction in the product transaction system but have been removed from the shelves by the system, etc., can be considered as products that are not in a transaction-available state.

In some optional examples, during selecting the alternative product for transaction, if there are multiple products with different transactions but with the same parameters of the functional effects that can be achieved, the product with a lower price can be automatically selected for transaction.

In some other optional examples, if the server that receives the product purchase request sent by the client finds that there is no target alternative product of which the selling price is not higher than a target selling price among alternative products available for transaction, at this time the server may inquire the client whether to increase the price to purchase. The step of “sending the product purchase request to the server, triggering the server to respond to the product purchase request, selecting an alternative product for transaction when the target product is in a transaction-unavailable state, and sending transaction event information of the alternative product” includes: sending the product purchase request to a server, to trigger the server to send price increase transaction information when the target product is in a transaction-unavailable state and the selling price of a first alternative product is higher than that of the target product, where the functional attribute value of the first alternative product is the same as the target functional attribute value of the target product.

The price increase transaction information may include the specific price of the first alternative product, the unit price difference between the first alternative product and the target product, and/or the total price difference between the first alternative product and the target product, etc.

Accordingly, the client of the target game may display prompt information related to the price increase transaction information. Before the step of “receiving the transaction event information of the alternative product”, the game product transaction method provided by the embodiment of the present disclosure may further include: receiving the price increase transaction information, and displaying a price increase transaction control in the product transaction system page based on the price increase transaction information; and in response to an operation for the transaction of the price increase transaction control, sending a transaction request to the server, to trigger the server to perform a transaction based on the first alternative product and send transaction success information of the alternative product.

In some embodiments, the price increase transaction control may include a sub-control that can be triggered to agree to the transaction and a sub-control that can be triggered to reject the transaction, etc.

Further, if the game user rejects the price increase transaction through the operation of a sub-client, for example triggering the sub-control for rejecting the transaction, the client can directly display prompt information of transaction failure and send transaction rejection information to the server so that the server can stop the transaction.

In some embodiments, if the server corresponding to the client successfully employs the first alternative product to perform an alternative transaction, at this time the client may prompt relevant information of the successful transaction. The step of “receiving the transaction event information of the alternative product and displaying the transaction event information on the product transaction system page” may specifically include: receiving the transaction success information of the alternative product and displaying the transaction success information in the product transaction system page.

Specifically, the transaction success information of the alternative product may be used for prompting the client that the transaction has been completed, or the transaction success information may also be used for prompting that the first alternative product has been selected for transaction.

In some embodiments, such as when the client is displayed in the product transaction system, the transaction success information of the alternative product may be directly displayed.

In some embodiments, the client may generate transaction success prompt information based on the transaction success information of the alternative product, and the content and form of the transaction success prompt information are not limited. For example, the transaction success prompt information may be in the form of a control, and the transaction success prompt information may also include a detail viewing control so that transaction detail information such as the transaction time, transaction quantity, and the user selling the product can be viewed through operation; or, in some embodiments, the transaction success prompt information may also include an interface jump control, through operation of which, the interface of the client can be jumped to the game scenario before the game user performs the transaction, or to the game scenario in which the first alternative product can be used, etc.

It can be understood that, when the target product is in a transaction-available state, the server can directly select the target product for transaction and send product transaction success information to prompt the server side to complete the transaction based on the target product. The client can receive the product transaction success information, and displays the product transaction success information in the product transaction system page.

For example, through a purchase operation for a game prop A in the product transaction system page of the client, the client generates a product purchase request for the game prop A and sends the product purchase request to the server. After receiving the product purchase request, the server detects that the game prop A among the products available for transaction is in a transaction-available state, and then the server can directly select the game prop A for transaction and send on-screen transaction success information for the game prop A. The client can receive the product transaction success information, and displays the product transaction success information in the product transaction system page.
204. the transaction event information of the alternative product is received, and the transaction event information is displayed in the product transaction system page.

The transaction event information of the alternative product may be information related to any event occurring during the alternative product transaction process. For example, after the server completes the transaction using the alternative product, the transaction event information of the alternative product may include information for prompting the client that the transaction has been completed.

In some embodiments, after the server selects the alternative product, the server may prompt the client whether to employ the alternative product for transaction through the transaction event information of the alternative product; and further, if the client rejects to employ the alternative product for transaction, at this time the transaction event information of the alternative product may include information for prompting transaction failure, etc.

Optionally, the transaction event information of the alternative product may also include product attribute information of the alternative product, etc., e.g. the functional attribute value, price, quantity, etc. of the alternative product.

It can be understood that in some cases, there may be products with lower prices but worse functional effects, products with higher prices but better functional effects, etc. At this time, the client may be prompted whether to perform transaction for this type of product. the step of “sending the product purchase request to a server, to trigger the server to, in response to the product purchase request, select an alternative product for transaction when the target product is in a transaction-unavailable state and send transaction event information of the alternative product” may specifically include: sending the product purchase request to the server, to trigger the server to send transaction selection information when the target product is in a transaction-unavailable state and only a second alternative product is transaction-available, where the functional attribute value of the second alternative product is different from that of the target product, or the functional attribute value of the second alternative product is the same as the target functional attribute value and the selling price of the second alternative product is higher than that of the target product.

In some embodiments, among the products in a transaction-available state, there may be a second alternative product of which the target function effect corresponding to the target function attribute value is the same as or better than that of the target product but the selling price is higher than that of the target product; or, in some embodiments, a second alternative product of which the target function effect corresponding to the target function attribute value is worse than that of the target product but the selling price is lower than that of the target product; or, in some embodiments, a second alternative product of which the target function effect is worse than that of the target product but the functional effects in other attributes are better than those of the target product.

At this time, the functional attribute values of a plurality of second alternative products and the difference between the selling prices of plurality of second alternative products and that of the target product may be sent to the client for reference by the client.

In some embodiments, before the step of “receiving the transaction event information of the alternative product”, the game product transaction method provided by the embodiment of the present disclosure may further include: receiving the transaction selection information, and displaying a transaction selection control in the product transaction system page based on the transaction selection information; and in response to an operation for the transaction of the transaction selection control, sending a transaction request to the server, to trigger the server to perform a transaction based on the second alternative product and send transaction success information of the alternative product.

It can be understood that, the transaction selection information may include relevant information such as attribute values of one or more second alternative products, and the transaction selection controls displayed on the client may correspond to respective second alternative products.

For example, by an operation of triggering a transaction selection control in the client, the client can determine a specific one available for transaction from several second alternative products for transaction with the server.

As can be seen from the above, in the embodiments of the present disclosure, the product transaction system page of the target game can be displayed. The product transaction system page includes a product identifier of at least one transaction-available product. A product purchase request is generated in response to the purchase operation for the target product, and the product purchase request is sent to the server, to trigger the server to respond to the product purchase request, select an alternative product for transaction when the target product is in a transaction-unavailable state, and sends transaction event information of the alternative product, receives the transaction event information of the alternative product, and displays transaction success information in the product transaction system page based on the transaction event information of the alternative product. Since in the embodiment of the present disclosure, when the target product that a user wants to purchase is not in a transaction-available state, an alternative product can be selected for transaction with the user, the effect of product information asynchrony caused by network delays and the like reasons is avoided, reducing the frequency of transaction failures of the game user, and reducing the number of requests from the game user for refreshing the product transaction system page and re-selecting a new product from the product transaction system page for transaction, which can improve the efficiency of product transaction performed by the game user and reduce the background load of game applications.

The embodiments of the present disclosure will be described from the perspective of a game product transaction apparatus, which may be specifically integrated in a server.

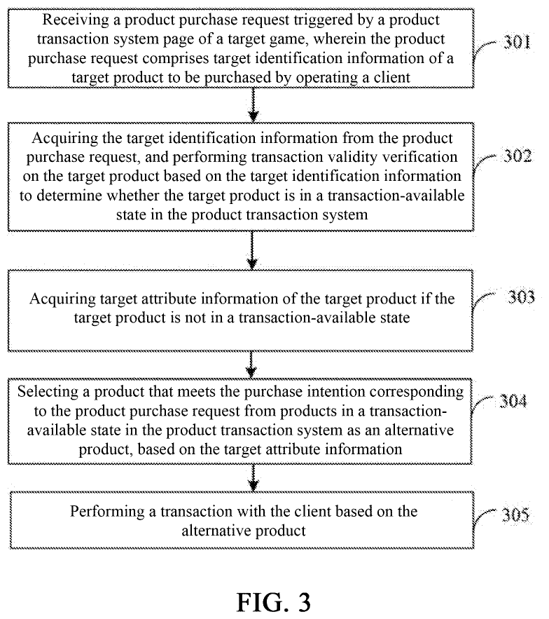

As shown in FIG. 3, a specific flow of the game product transaction method of this embodiment may be as follows.
301. a product purchase request triggered by a product transaction system page of a target game is received, where the product purchase request includes target identification information of a target product to be purchased by operating a client.

In some embodiments, the target identification information is information that can distinguish the target product from other products in the product transaction system. For example, the target identification information may be an unique number of the target product in the product transaction system, or, in some embodiments, the target identification information may be a group of information consisting of the product name of the target product, the user number of a selling user, etc.

As shown in FIG. 3, the product transaction system page may include products that can be triggered by a user, and these products may be products that are put onto the shelves by the product selling user through the product transaction system.

It can be understood that, when selling a product, the selling user can set the quantity, price, etc. of the product through the product transaction system. In some examples, some products may not be allowed to be sold due to limitation of game rules. Therefore, the product transaction system can conduct product validity validation on the products put onto the shelves by the selling user. If the product passes the product validity verification, it will be displayed in the product transaction system page.
302. the target identification information is acquired from the product purchase request, and transaction validity verification is performed on the target product based on the target identification information to determine whether the target product is in a transaction-available state in the product transaction system.

It can be understood that, in addition to the target identification information, the product purchase request may also include other information, such as but not limited to request generation time, user information of the game user who initiates the request, and the like. A skilled person can set the information included in the product purchase request according to actual applications.

In some embodiments, the transaction validity verification may be to search for the target product corresponding to the target identification information from all products that have been put onto the shelves in the product transaction system, and then determine the current status of the target product.

Specifically, all products that have been put onto the shelves in the product transaction system may include products that are in a transaction-available state in the product transaction system, products that have completed transaction through the product transaction system, and products that have not completed transaction through the product transaction system but have been removed from the shelves by the selling user himself or herself or automatically removed from the shelves by the product transaction system.

In some other embodiments, the transaction validity verification may be to search whether there is a target product corresponding to the target identification information among products in a transaction-available state in the product transaction system.

Through the transaction validity verification, it can be determined whether the target product to be purchased via operation of the client is currently purchasable, namely, whether it is in a transaction-available state in the product transaction system.

The transaction-available state refers to the state in which the product can be purchased, exchanged, etc. by the client in the product transaction system.

In some embodiments, if the target product is in a transaction-available state, the transaction may be directly conducted with the client based on the target product.
303. target attribute information of the target product is acquired if the target product is not in a transaction-available state.

In some examples, in order to facilitate a game user to select a target product they want to purchase from a large number of products, generally, when the product transaction system page is displayed, the attribute information of the product can be stored in a device at the client for the user to view. Therefore, when a product purchase request is generated for a target game, the target attribute information of the target product stored in the product transaction system can be directly added into the product purchase request. During acquiring the target attribute information of the target product, the product purchase request may be parsed to obtain the target attribute information.

In some other examples, in order to reduce the transmission pressure of the target game between the client and the server, the device at the client may not store or only store all or part of the attribute information of some products. During acquiring the target attribute information of the target product, in order to ensure the accuracy and reliability of the target attribute information, the target attribute information of the target product can be searched from the game background of the target game according to the target identification information.

Specifically, the target attribute information may be all information related to the target product, including but not limited to the selling user information, type, quantity, selling price of the target product, and parameters of functional effects that the target product can achieve. In some embodiments, the target attribute information may be information only related to the transaction of the target product, such as the type, quantity, and selling price of the target product and parameters of the functional effects that the target product can achieve.

The parameters of the functional effects that the target product can achieve may include, but are not limited to, parameters of the gain or loss effects that the target product brings to the health value, attack power, defense power, etc. of a game character.
304. a product that meets the purchase intention corresponding to the product purchase request from products in a transaction-available state in the product transaction system is selected as an alternative product based on the target attribute information.

The alternative product is a product that replaces the target product and is subjected to transaction with the client.

In some embodiments, the product that meets the purchase intention of the client may be other products sold by the selling user of the target product among the products in a transaction-available state in the product transaction system, or may be products required by the game user automatically determined based on the current game scenario of the game character operated by the game user.

For example, when a game character operated by a game user is in a battle scenario and the health value of the game character is less than 50% of the original health value, if the target product selected by the game user through operating the client is of the treatment type, it can be predicted that the purchase intention corresponding to the product purchase request is to purchase a treatment-type product. At this time, the treatment-type products in the transaction-available state in the product transaction system can be used as alternative products.

In some embodiments, the accuracy of selecting alternative products can be improved by attribute information matching. The step of “selecting a product that meets the purchase intention corresponding to the product purchase request from the products in the transaction-available state in the product transaction system as an alternative product, based on the target attribute information” can specifically include: selecting a product that matches the target attribute information from products in a transaction-available state in the product transaction system as an alternative product, based on the target attribute information.

Specifically, matching the target attribute information may mean that the attribute information of the product is completely identical to the target attribute information, or that the attribute information of the product satisfies a matching condition determined based on the target attribute information, etc.

In some embodiments, the matching condition determined based on the target attribute information may be that the product types of the product and the target product match, and the difference in the attribute values between the product and the target product does not exceed a preset difference range.

In some embodiments, the target attribute information may include the target attribute type and the target attribute value, and the step of “selecting a product matching the target attribute information from products in a transaction-available state as an alternative product, based on the target attribute information” may specifically include: selecting a product matching the target attribute type from the products in a transaction-available state as a first candidate product, based on the target attribute type; and acquiring the attribute value of the first candidate product, and using the first candidate product of which the difference between the attribute value and the target attribute value is within a preset difference range as an alternative product.

In some examples, matching the target attribute type may refer to that the attribute type of the product is exactly the same as the target attribute type. In some other examples, the target attribute type may include types with different hierarchical relationships, and matching with the target attribute type may be matching a type at any level in the target attribute type.

For example, for the treatment type, treatment subtype 1 and treatment subtype 2 may be set under the treatment type, and the target attribute type may be the treatment subtype 1 under the treatment type. Matching the target attribute type may refer to that the product only needs to belong to the treatment type, or may refer to that the attribute type of the product must be the treatment subtype 1 under the treatment type.

Specifically, the preset difference range may be 0, namely, there is no attribute value difference between the attribute value and the target attribute value, and the attribute value of the alternative product is completely the same as the target attribute value of the target product. In some embodiments, the preset difference range may be an interval range, and there may be a certain difference between the attribute value of the alternative product and the target attribute value of the target product.

The preset difference range may be set by a skilled person, or may be set by a user himself or herself in the target game by operating the client, and this embodiment of the present disclosure does not limit this.

It can be understood that, the target attribute value may include parameters describing the target product from different dimensions. For example, the target attribute value may include a target quantity and a target associated attribute value, and the attribute value of the first candidate product may include a transaction-available quantity of the first candidate product and an associated attribute value of the first candidate product.

The target quantity may be a description of the target product from the perspective of transaction quantity, and the target-associated attribute value may be an attribute parameter of other dimensions in the target attribute value except the target quantity, e.g. product price, product validity period, etc.

Similarly, the transaction-available quantity can be a description of the first candidate product from the dimension of the transaction-available quantity, and the target-associated attribute value can be an attribute parameter of other dimensions in the attribute value of the first candidate product except the transaction-available quantity, e.g. the product price, parameters of the functional effects that the first candidate product can achieve, etc.

In some embodiments, if there is a product of which other attributes except quantity can satisfy the purchase intention corresponding to the product purchase request, the product transaction can be directly carried out, and the step of “acquiring the attribute value of the first candidate product, and taking the first candidate product of which the attribute value difference between the attribute value and the target attribute value is within a preset difference range as an alternative product” can specifically include: acquiring the transaction-available quantity of the first candidate product and the associated attribute value of the first candidate product; and using the first candidate product as an alternative product if the associated attribute value of the first candidate product is the same as the target associated attribute value.

Accordingly, the step of “performing a transaction with a client based on an alternative product” may include: performing a transaction with the client based on the transaction-available quantity of the alternative product.

The transaction-available quantity and the quantity of the target product that the client actually wants to purchase may be the same as or different from each other, and this embodiment of the present disclosure does not limit this. The quantity of the alternative product subjected to transaction with the client is less than or equal to the quantity of the target product.

Specifically, when a selling user puts a target product onto shelves in the product transaction system, the product transaction system may split the product of the selling user into smallest units. Therefore, the products that a user who purchases products can see through the product transaction system can all be in the smallest unit state and the selling price of the target product can be the unit price.

The product purchase request sent by the client may include a product attribute value, a unit price, a quantity, etc. When a transaction is performed, the product transaction system may implement the principle of quick payment. In some embodiments, the quantity of the product subjected to transaction may be less than or equal to the purchase quantity in the purchase intention corresponding to the product purchase request.

In some optional embodiments, there may the situation in which the quantity of products that meet the purchase intention corresponding to the product purchase request among the first candidate products is less than the target quantity that the client wants to purchase. At this time, it can be selected whether to still perform transaction for the insufficient number of alternative products via the client. The step of “using the first candidate product as an alternative product if the associated attribute value of the first candidate product is the same as the target associated attribute value” may include.

If the associated attribute value of the first candidate product is the same as the target associated attribute value, and the transaction-available quantity of the first candidate product is less than the target quantity of the target product, the first candidate product is used as an alternative product.

In some embodiments, the first candidate product may be a product of which the quantity is less than the target quantity but other attribute values are the same as those of the target product.

Accordingly, if the quantity of the first candidate product cannot satisfy the purchase quantity in the purchase intention corresponding to the product purchase request, at this time the client may be prompted to confirm whether to purchase some of the products. The step of “performing a transaction with the client based on the transaction-available quantity of the alternative product” may specifically include: determining the difference in transaction quantity between the alternative product and the target product, based on the transaction-available quantity of the alternative product; sending transaction selection information including the transaction quantity difference to the client, triggering the client to display a transaction selection control including the transaction quantity difference based on the transaction selection information; and receiving a transaction request triggered by the transaction selection control, and performing a transaction with the client based on the transaction request and the alternative product.

The transaction quantity difference may be the difference between the transaction-available quantity and the target quantity.

Specifically, in addition to the transaction quantity difference, the transaction selection control may also include, but is not limited to, a transaction confirmation control, a transaction rejection control, and/or a quantity selection control for the client to select a specific transaction quantity, etc.

For example, the quantity of target products in the purchase intention corresponding to the product purchase request may be 10, but the quantity of alternative products is only 8. At this time, the client may be prompted that the transaction quantity difference is 2, and the client may select not to perform transaction, or may select 1-8 alternative products for transaction.

It can be understood that, the alternative products may be products sold by the same product selling user, or may be products sold by multiple product selling users, and the embodiments of the present disclosure do not limit this.

For example, the quantity of target products in the purchase intention may be 10, and the alternative products may include 3 alternative products sold by a product selling user 1, 5 alternative products sold by a product selling user 2, and there are no other alternative products among the products in the transaction-available state.

In some other optional embodiments, there may be the situation in which the quantity of target products in the purchase intention is smaller than the quantity of alternative products that a user selling a certain product packages and sells at one time. At this time, the user selling the product may be prompted whether to split the product for sale. In some embodiments, the target attribute value may include a target quantity and a target associated attribute value, and the attribute value of the first candidate product may include a package transaction-available quantity of the first candidate product and an associated attribute value of the first candidate product.

The step of “acquiring the attribute value of the first candidate product, and using the first candidate product of which the difference between the attribute value and the target attribute value is within a preset difference range as an alternative product” includes: acquiring the package transaction-available quantity of the first candidate product and the associated attribute value of the first candidate product; and if the associated attribute value of the first candidate product is the same as the target associated attribute value, and the package transaction-available quantity of the first candidate product is greater than the target quantity, the first candidate product is used as an alternative product.

In some embodiments, the first candidate product may be a product of which the quantity is greater than the target quantity but other attribute values are the same as those of the target product.

Accordingly, if the quantity of the first candidate products is greater than the quantity of the target products corresponding to the purchase intention, at this time the product selling user may be prompted to confirm whether to split and sell the products that he or she originally wanted to sell in one package. The step of “performing a transaction with the client based on the alternative product” may specifically include: sending split transaction information to a client corresponding to the product selling user of the alternative product based on the alternative product, where the split transaction information including the target quantity, and triggering the client to display a split transaction selection control including the target quantity based on the split transaction information; and receiving a split transaction request triggered by the product selling user via the split transaction selection control, and performing a transaction with the client based on the split transaction request and the alternative product.

In some embodiments, a user who sells the product can select whether to split him or her products for sale.

Specifically, in addition to the target quantity, the split transaction selection control may also include but is not limited to a split transaction confirmation control and/or a split transaction rejection control.

For example, the quantity of alternative products that the product selling user wants to sell may be 20, but the quantity of target products corresponding to the purchase intention is only 15. At this time, the product selling user can be prompted that a certain user wants to purchase 15 products, and the product selling user can select to perform or not perform the transaction.

It can be understood that, the alternative products may be products sold by the same product selling user, or may be products sold by multiple product selling users, and the embodiments of the present disclosure do not limit this.

For example, the quantity of target products corresponding to the purchase intention may be 15, and the alternative products may include 5 alternative products sold by a product selling user 1, 20 alternative products sold by a product selling user 2, and there are no other alternative products among the products in the transaction-available state.

At this time, the product selling user 2 can be inquired whether the product can be split for sale. If the product selling user 2 rejects to split the product for sale, the client may be inquired whether he or she wants to purchase part of the product.

It can be understood that, if the transaction-available quantity of the first candidate product is the same as the target quantity, and other attribute values of the first candidate product are also the same as those of the target product, the transaction can be directly performed with the client based on the first candidate product.
305. a transaction is performed with the client based on the alternative product.

If the supply of the alternative product is greater than the purchasing demand of the client, when transaction with the client is performed based on the alternative product, some alternative products can be selected from the alternative products for transaction with the client based on the prices of the alternative products, parameters of the functional effects that the alternative products can achieve, etc.

During selecting the alternative products for transaction, if the parameters of the functional effects that can be achieved are the same, a product with a lower price can be automatically selected for transaction with the client. In some embodiments, the target attribute value may include a target selling price and a target functional attribute value, the attribute value may include a selling price and a functional attribute value, and the step of “conducting a transaction with the client based on the alternative product” includes: determining a first alternative product of which functional attribute values are the same as the target functional attribute values from the alternative products, based on the functional attribute values of the alternative products; and if there is a target alternative product of which the selling price is not higher than the target selling price among the first alternative products, a transaction is performed with the client based on the target alternative product.

The functional attribute values are used for describing the parameters of the functional effects that can be achieved by the alternative products. For example, the functional attribute values may include but are not limited to the health value gain, attack power gain, defense power gain and/or treatment value of each alternative product. The target functional attribute value is used for describing the parameters of the functional effect that the target product can achieve.

In some embodiments, if there are n first alternative products that can achieve the same functional effects as the target product, and there is a target alternative product of which the selling price is lower than that of the target product among the first alternative products, the target alternative product can be directly used for transaction with the client.

In some embodiments, if there is no target alternative product of which the selling price is not higher than the target selling price among the first alternative products, at this time the client may be inquired whether to purchase at an increased price. In some embodiments, the game product transaction method provided by the embodiment of the present disclosure may further include: if there is no target alternative product of which the selling price is not higher than the target selling price among the first alternative products, sending price increase transaction information to the client, to trigger the client to display a price increase transaction selection control based on the price increase transaction information; and receiving a transaction request generated by operating the price increase transaction selection control in the client, and performing a transaction with the client based on the transaction request and the first alternative product.

If the client rejects the transaction with an increased price, the client may be prompted that the transaction has failed.

It can be understood that in some cases, there may be products with lower prices but worse functional effects, products with higher prices but better functional effects, etc. At this time, the client may be prompted whether to perform transaction for this type of product. In some embodiments, the target attribute value includes a target selling price and a target functional attribute value, the attribute value includes a selling price and a functional attribute value, and the step of “conducting a transaction with the client based on the alternative product” may specifically include: determining a second alternative product of which the functional attribute value is different from the target functional attribute value, or of which the functional attribute value is the same as the target functional attribute value but the selling price is higher than the target selling price among the alternative products, based on the functional attribute values of the alternative products; determining product difference information between the second alternative product and the target product based on the selling price and functional attribute value of the second alternative product; sending transaction selection information including the product difference information to the client, to trigger the client to display a transaction selection control including the product difference information based on the transaction selection information; and receiving a transaction request generated by operating the transaction selection control in the client, and performing a transaction with the client based on the transaction request and the second alternative product.

In some embodiments, among the products in a transaction-available state, there may be a second alternative product of which the target function effect corresponding to the target function attribute value is the same as or better than that of the target product but the selling price is higher than that of the target product; or, in some embodiments, a second alternative product of which the target function effect corresponding to the target function attribute value is worse than that of the target product but the selling price is lower than that of the target product; or, in some embodiments, a second alternative product of which the target function effect is worse than that of the target product but the functional effects in other attributes are better than those of the target product.

At this time, the functional attribute values of a plurality of second alternative products and the difference between the selling prices of plurality of second alternative products and that of the target product may be sent to the client for reference by the client.

The client can select a second alternative product available for transaction for particular transaction in the transaction selection control.

In some optional examples, during determining the second alternative product, a product that meets certain similarity conditions with the target product may be selected from the alternative products as the second alternative product. For example, it may be possible to limit the difference between one or some functional attribute values of the second alternative product and the target functional attribute value to not be higher or lower than a specific value, etc.

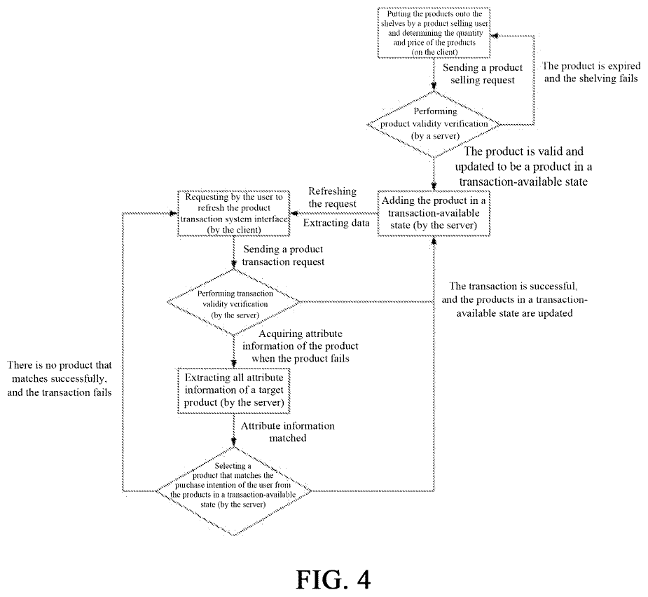

In some embodiments, as shown in FIG. 4, after a successful transaction with the client, the products in the product transaction system that are in a transaction-available state may be refreshed, and the state of the sold product may be updated to be not in a transaction-available state, etc.

As can be seen from the above, the embodiments of the present disclosure can receive the product purchase request triggered by the product transaction system page of the target game. The product purchase request includes target identification information of the target product to be purchased by operating the client. The target identification information is obtained from the product purchase request, and transaction validity verification is performed on the target product based on the target identification information to determine whether the target product is in a transaction-available state in the product transaction system. If the target product is not in a transaction-available state, the target attribute information of the target product is obtained, and a product that meets the purchase intention corresponding to the product purchase request is selected from the products in the transaction-available state in the product transaction system as an alternative product based on the target attribute information, and the transaction is conducted with the client based on the alternative product. Since in the embodiments of the present disclosure, when the target product that the user wants to purchase is not in a transaction-available state, a product that meets the purchase intention of the user is selected from the products in the transaction-available state in the product transaction system for transaction with the user, the effect of product information asynchrony caused by network delays and the like reasons is avoided, reducing the frequency of transaction failures of the game user, and reducing the number of requests from the game user for refreshing the product transaction system page and re-selecting a new product from the product transaction system page for transaction, which can improve the efficiency of product transaction performed by the game user and reduce the background load of game applications.

The embodiments of the present disclosure will be described from the perspective of a game product transaction apparatus, which may be specifically integrated in a client and a server.

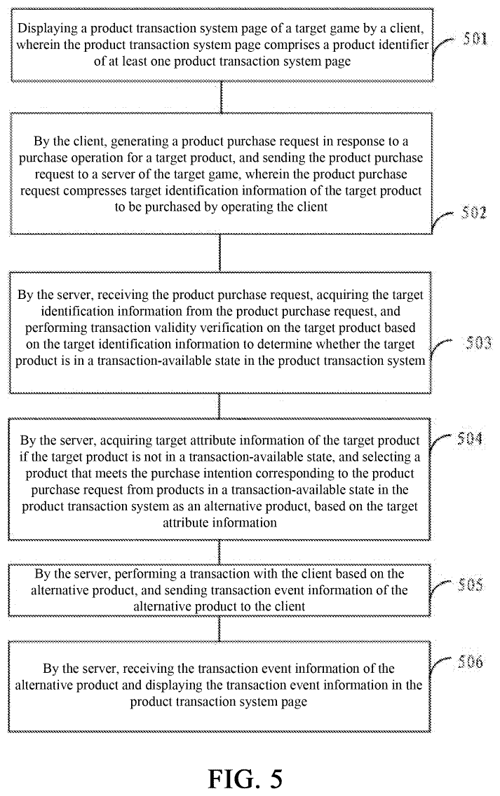

As shown in FIG. 5, a specific flow of the game product transaction method of this embodiment may be as follows.
501. the client displays a product transaction system page of a target game, where the product transaction system page includes a product identifier of at least one product available for transaction.

In the embodiments of the present disclosure, the explanations of various terms can refer to the aforementioned embodiments, and this will not be described in detail any more in the embodiments of the present disclosure.
502. the client generates a product purchase request in response to a purchase operation for a target product, and sends the product purchase request to a server of the target game, where the product purchase request includes target identification information of the target product to be purchased by operating the client.
503. the server receives the product purchase request, acquires the target identification information from the product purchase request, and performs transaction validity verification on the target product based on the target identification information to determine whether the target product is in a transaction-available state in the product transaction system.
504. the server acquires target attribute information of the target product if the target product is not in a transaction-available state, and selects a product that meets the purchase intention corresponding to the product purchase request from products in a transaction-available state in the product transaction system as an alternative product, based on the target attribute information.
505. the server performs a transaction with the client based on the alternative product, and sends transaction event information of the alternative product to the client.

Specifically, when the server performs a transaction with the client based on the alternative product, the process of selecting the target alternative product, the first alternative product or the second alternative product for transaction in the aforementioned embodiment may be referred, which will not be described in detail any more here in the embodiment of the present disclosure.
506. the client receives the transaction event information of the alternative product, and displays the transaction event information in the product transaction system page.

As can be seen from the above, the embodiments of the present disclosure can avoid the effect of product information asynchrony caused by network delays and the like reasons, reduce the frequency of transaction failures of the game client, and reduce the number of requests for the game client to refresh the product transaction system page and re-select a new product from the product transaction system page for transaction. This can improve the efficiency of the game client in performing product transactions and reduce the background load of game applications.

The method described in the aforementioned embodiments is further described in detail hereafter with examples.

In this embodiment, description will be given in conjunction with the system in FIG. 1.

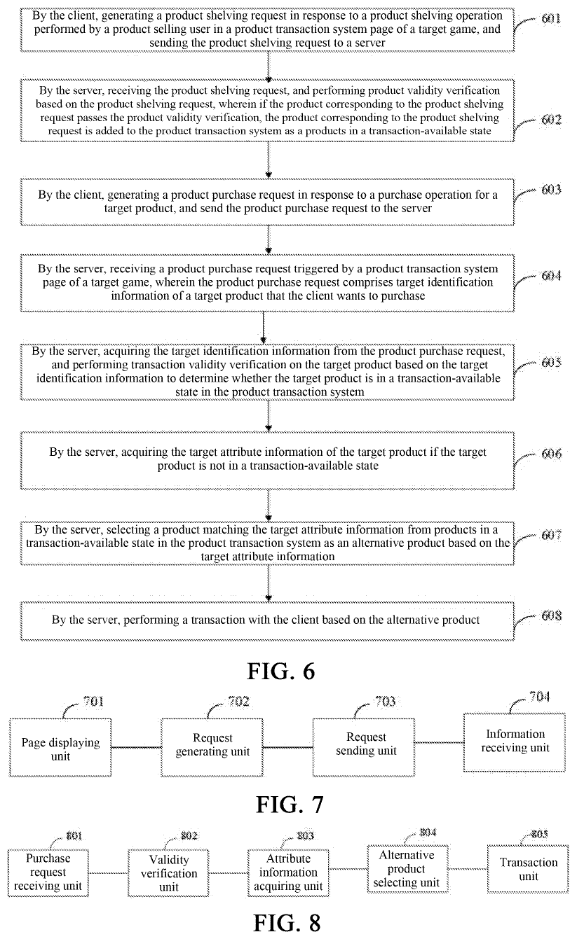

As shown in FIG. 6, a specific flow of the game product transaction method of this embodiment may be as follows.
601. the client generates a product shelving request in response to a product shelving operation performed by a product selling user in a product transaction system page of a target game, and sends the product shelving request to a server.
602. the server receives the product shelving request, and performs product validity verification based on the product shelving request. If the product corresponding to the product shelving request passes the product validity verification, the product corresponding to the product shelving request is added to the product transaction system as a products in a transaction-available state.

Specifically, the product selling user (seller) puts the products onto shelves, and the server conducts product validity verification on the server side. After the verification is successful, the products are added to the products in the product transaction system that are in a transaction-available state.
603. the client generates a product purchase request in response to a purchase operation for a target product, and send the product purchase request to the server.
604. the server receives a product purchase request triggered by a product transaction system page of a target game, where the product purchase request includes target identification information of a target product that the client wants to purchase.

Specifically, a user (buyer) enters the product transaction system page through the client, and selects and purchases the product, and the transaction data can be submitted to the server for validity verification.
605. the server acquires the target identification information from the product purchase request, and performs transaction validity verification on the target product based on the target identification information to determine whether the target product is in a transaction-available state in the product transaction system.

If the target product is in a transaction-available state in the product transaction system, it can be purchased directly. After a successful purchase, the products in the product transaction system that are in a transaction-available state can be updated.
606. the server acquires the target attribute information of the target product if the target product is not in a transaction-available state.
607. the server selects a product matching the target attribute information from products in a transaction-available state in the product transaction system as an alternative product based on the target attribute information.

If the target product is not in a transaction-available state in the product transaction system (the product has expired), all the attribute information of the product purchased by the buyer (the target product) can be extracted, and a product that fully meets the purchase intention of the buyer can be searched from the products in a transaction-available state in the product transaction system as an alternative product, and the payment of the transaction is completed.
608. the server performs a transaction with the client based on the alternative product.

As can be seen from the above, in the embodiments of the present disclosure, a product that meets the purchase intention of the user is selected from the products in the product transaction system that are in a transaction-available state for transaction with the user when the target product that the user wants to purchase is not in a transaction-available state. Therefore, the effect of product information asynchrony caused by network delays and the like reasons is avoided, reducing the frequency of the game user, and reducing the number of requests from the game user for refreshing the product transaction system page and re-selecting a new product from the product transaction system page for transaction, which can improve the efficiency of product transaction performed by the game user and reduce the background load of game applications.

In order to better implement the aforementioned method, accordingly, the embodiment of the present disclosure further provides a game product transaction apparatus.

Referring to FIG. 7, the apparatus includes: a page displaying unit 701 for displaying a product transaction system page of a target game, where the product transaction system page includes a product identifier of at least one product available for transaction; a request generating unit 702 for generating a product purchase request in response to a purchase operation for a target product; a request sending unit 703 for sending the product purchase request to a server, to trigger the server to, in response to the product purchase request, select an alternative product for transaction when the target product is in a transaction-unavailable state and send transaction event information of the alternative product; and an information receiving unit 704 for receiving the transaction event information of the alternative product, and displaying transaction success information in the product transaction system page based on the transaction event information of the alternative product.

In some optional embodiments, the request sending unit 703 is used for sending the product purchase request to a server, to trigger the server to send price increase transaction information when the target product is in a transaction-unavailable state and the selling price of a first alternative product is higher than that of the target product, where the functional attribute value of the first alternative product is the same as the target functional attribute value of the target product.

The game product transaction apparatus provided by the embodiment of the present disclosure further includes a price increase transaction selection unit for receiving the price increase transaction information, and displaying a price increase transaction control in the product transaction system page based on the price increase transaction information; and in response to an operation for the transaction of the price increase transaction control, sending a transaction request to the server, to trigger the server to perform a transaction based on the first alternative product and send transaction success information of the alternative product.

The information receiving unit 704 is used for receiving the transaction success information of the alternative product, and displaying transaction success information in the product transaction system page based on the transaction event information of the alternative product.

In some optional embodiments, the request sending unit 703 is used for sending the product purchase request to the server, to trigger the server to send transaction selection information when the target product is in a transaction-unavailable state and only a second alternative product is transaction-available, where the functional attribute value of the second alternative product is different from that of the target product, or the functional attribute value of the second alternative product is the same as the target functional attribute value and the selling price of the second alternative product is higher than that of the target product.

The game product transaction apparatus provided by the embodiments of the present disclosure further includes a transaction selection unit for receiving the transaction selection information and displaying a transaction selection control in the product transaction system page based on the transaction selection information; and in response to an operation for the transaction of the transaction selection control, sending a transaction request to the server, to trigger the server to perform a transaction based on the second alternative product and send transaction success information of the alternative product.

The information receiving unit 704 is used for receiving the transaction success information of the alternative product, and displaying transaction success information in the product transaction system page based on the transaction event information of the alternative product.

As can be seen from the above, by the game product transaction apparatus, it can avoid the effect of product information asynchrony caused by network delays and the like reasons, reduce the frequency of transaction failures of the game client, and reduce the number of requests for the game client to refresh the product transaction system page and re-select a new product from the product transaction system page for transaction. This can improve the efficiency of the game client in performing product transactions and reduce the background load of game applications.

In order to better implement the aforementioned method, accordingly, the embodiment of the present disclosure further provides a game product transaction apparatus.

Referring to FIG. 8, the apparatus includes: a purchase request receiving unit 801 that can be used for receiving a product purchase request triggered by a product transaction system page of a target game, where the product purchase request can include target identification information of a target product to be purchased by operating a client; a validity verification unit 802 that can be used for acquiring the target identification information from the product purchase request, and performing transaction validity verification on the target product based on the target identification information to determine whether the target product is in a transaction-available state in the product transaction system; an attribute information acquiring unit 803 that can be used for acquiring target attribute information of the target product if the target product is not in a transaction-available state; an alternative product selecting unit 804 that can be used for selecting a product that meets the purchase intention corresponding to the product purchase request from products in a transaction-available state in the product transaction system as an alternative product, based on the target attribute information; and a transaction unit 805 that can be used for performing a transaction with the client based on the alternative product.

In some optional embodiments, the alternative product selecting unit can be used for selecting a product that matches the target attribute information from products in a transaction-available state in the product transaction system as an alternative product, based on the target attribute information.

In some optional embodiments, the target attribute information may include a target attribute type and a target attribute value, and the alternative product selecting unit 804 can be used for selecting a product matching the target attribute type from products in a transaction-available state as a first candidate product based on the target attribute type; and acquiring the attribute value of the first candidate product, and using the first candidate product of which the difference between the attribute value and the target attribute value is within a preset difference range as an alternative product.

In some optional embodiments, the target attribute value may include a target selling price and a target functional attribute value, and the attribute value may include a selling price and a functional attribute value.

The transaction unit 805 can be used for determining a first alternative product of which functional attribute values are the same as the target functional attribute values from the alternative products, based on the functional attribute values of the alternative products; and if there is a target alternative product of which the selling price is not higher than the target selling price among the first alternative products, a transaction is performed with the client based on the target alternative product.

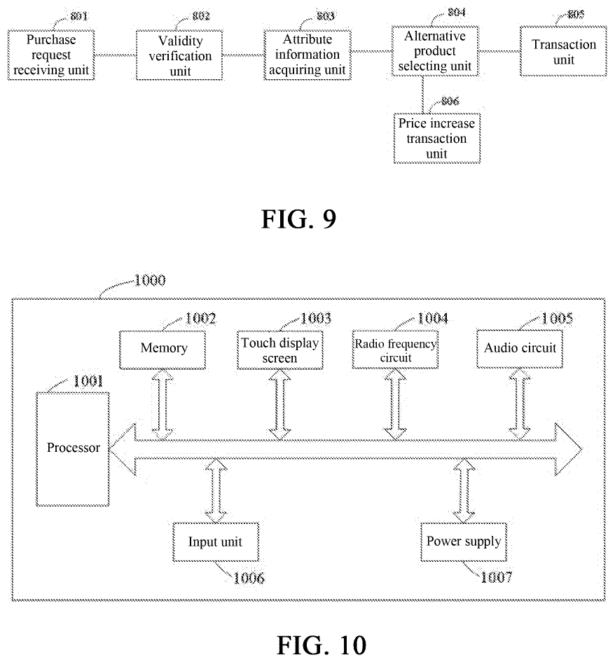

In some optional embodiments, as shown in FIG. 9, the game product transaction apparatus provided by the embodiment of the present disclosure further includes a price increase transaction unit 806 for if there is no target alternative product of which the selling price is not higher than the target selling price among the first alternative products, sending price increase transaction information to the client, to trigger the client to display a price increase transaction selection control based on the price increase transaction information; and receiving a transaction request generated by operating the price increase transaction selection control in the client, and performing a transaction with the client based on the transaction request and the first alternative product.

In some optional embodiments, the target attribute value may include a target quantity and a target associated attribute value, and the attribute value of the first candidate product may include a transaction-available quantity of the first candidate product and an associated attribute value of the first candidate product.

The alternative product selecting unit 804 can be used for acquiring the transaction-available quantity of the first candidate product and the associated attribute value of the first candidate product; and using the first candidate product as an alternative product, if the associated attribute value of the first candidate product is the same as the target associated attribute value, and the transaction-available quantity of the first candidate product is less than the target quantity of the target product.

The transaction unit 805 can be used for performing a transaction with the client based on the transaction-available quantity of the alternative products.

In some optional embodiments, the target attribute value includes a target selling price and a target functional attribute value, and the attribute value includes a selling price and a functional attribute value.

The transaction unit 805 is used for determining a second alternative product of which the functional attribute value is different from the target functional attribute value, or of which the functional attribute value is the same as the target functional attribute value but the selling price is higher than the target selling price among the alternative products, based on the functional attribute values of the alternative products; determining product difference information between the second alternative product and the target product based on the selling price and functional attribute value of the second alternative product; sending transaction selection information including the product difference information to the client corresponding to the client, to trigger the client to display a transaction selection control including the product difference information based on the transaction selection information; and receiving a transaction request generated by operating the transaction selection control in the client, and performing a transaction with the client based on the transaction request and the second alternative product.

As can be seen from the above, the game product transaction apparatus can receive the product purchase request triggered by the product transaction system page of the target game. The product purchase request includes target identification information of the target product that the client wants to purchase. The target identification information is obtained from the product purchase request, and transaction validity verification is performed on the target product based on the target identification information to determine whether the target product is in a transaction-available state in the product transaction system. If the target product is not in a transaction-available state, the target attribute information of the target product is obtained, and a product that meets the purchase intention of the client is selected from the products in the transaction-available state in the product transaction system as an alternative product based on the target attribute information, and the transaction is conducted with the client based on the alternative product. Since in the embodiments of the present disclosure, when the target product that the client wants to purchase is not in a transaction-available state, a product that meets the purchase intention of the client is selected from the products in the transaction-available state in the product transaction system for transaction with the client, the effect of product information asynchrony caused by network delays and the like reasons is avoided, reducing the frequency of transaction failures of the game client, and reducing the number of requests from the game client for refreshing the product transaction system page and re-selecting a new product from the product transaction system page for transaction, which can improve the efficiency of product transaction performed by the game client and reduce the background load of game applications.

In order to better implement the aforementioned method, accordingly, the embodiment of the present disclosure further provides a game product transaction system.

Referring to FIG. 1, the game product transaction system includes a client 10 and a server 20.

The client 10 is used for displaying a product transaction system page of a target game, where the product transaction system page includes a product identifier of at least one product available for transaction.

The client 10 is used for generating a product purchase request in response to a purchase operation for a target product, and sending the product purchase request to a server of the target game, where the product purchase request includes target identification information of the target product to be purchased by operating the client.

The server 20 is used for receiving the product purchase request, acquiring the target identification information from the product purchase request, and performing transaction validity verification on the target product based on the target identification information to determine whether the target product is in a transaction-available state in the product transaction system.

The server 20 is used for acquiring target attribute information of the target product if the target product is not in a transaction-available state, and selecting a product that meets the purchase intention corresponding to the product purchase request from products in a transaction-available state in the product transaction system as an alternative product, based on the target attribute information.

The server 20 is used for performing a transaction with the client based on the alternative product, and sending transaction event information of the alternative product to the client.

The client 20 receives the transaction event information of the alternative product, and displays the transaction event information in the product transaction system page.

The client 10 may be provided with a game product transaction apparatus applicable to the client 10; and the server 20 may be provided with a game product transaction apparatus applicable to the server 20.

Specifically, in the embodiments of the present disclosure, the explanations of various terms and the specific operation implementations of the client 10 and the server 20 can refer to the aforementioned embodiments, and this will not be described in detail any more in the embodiments of the present disclosure.

As can be seen from the above, by the game product transaction system, it can avoid the effect of product information asynchrony caused by network delays and the like reasons, reduce the frequency of transaction failures of the game client, and reduce the number of requests for the game client to refresh the product transaction system page and re-select a new product from the product transaction system page for transaction. This can improve the efficiency of the game client in performing product transactions and reduce the background load of game applications.

Accordingly, an embodiment of the present disclosure further provides a computer device, which may be a terminal or a server. As shown in FIG. 10, FIG. 10 is a schematic structural diagram of the computer device provided in the embodiment of the present disclosure. The computer device 1000 includes a processor 1001 having one or more processing cores, a memory 1002 having one or more computer-readable storage media, and a computer program stored on the memory 1002 and runnable on the processor. The processor 1001 is electrically connected to the memory 1002. It can be understood by those skilled in the art that, the structure of the computer device shown in the figure does not constitute any limitation to the computer device, and may include more or fewer components than those shown in the figure, or may combine some components, or may have different component arrangements.

The processor 1001 is a control center of the computer device 1000, which connects various parts of the entire computer device 1000 using various interfaces and wires, implements various functions of the computer device 1000 and implements data processing by running or loading software programs and/or modules stored in the memory 1002, and invoking data stored in the memory 1002, thereby performing overall monitoring on the computer device 1000.

In an embodiment of the present disclosure, the processor 1001 in the computer device 1000 will load instructions corresponding to processes of one or more application programs into the memory 1002 following the steps hereafter, and the processor 1001 runs the application programs stored in the memory 1002, thereby implementing various functions: displaying a product transaction system page of a target game, where the product transaction system page includes a product identifier of at least one product available for transaction; generating a product purchase request in response to a purchase operation for a target product; sending the product purchase request to a server, to trigger the server to, in response to the product purchase request, select an alternative product for transaction when the target product is in a transaction-unavailable state and send transaction event information of the alternative product; and receiving the transaction event information of the alternative product and displaying the transaction event information in the product transaction system page.

In some optional embodiments, the sending the product purchase request to a server, to trigger the server to, in response to the product purchase request, select an alternative product for transaction when the target product is in a transaction-unavailable state and send transaction event information of the alternative product includes: sending the product purchase request to a server, to trigger the server to send price increase transaction information when the target product is in a transaction-unavailable state and the selling price of a first alternative product is higher than that of the target product, where the functional attribute value of the first alternative product is the same as the target functional attribute value of the target product.

Before receiving the transaction event information of the alternative product, the method further includes: receiving the price increase transaction information, and displaying a price increase transaction control in the product transaction system page based on the price increase transaction information; and in response to an operation for the transaction of the price increase transaction control, sending a transaction request to the server, to trigger the server to perform a transaction based on the first alternative product and send transaction success information of the alternative product.

The receiving the transaction event information of the alternative product and displaying the transaction event information in the product transaction system page includes: receiving the transaction success information of the alternative product and displaying the transaction success information in the product transaction system page.

In some optional embodiments, the sending the product purchase request to a server, to trigger the server to, in response to the product purchase request, select an alternative product for transaction when the target product is in a transaction-unavailable state and send transaction event information of the alternative product includes: sending the product purchase request to the server, to trigger the server to send transaction selection information when the target product is in a transaction-unavailable state and only a second alternative product is transaction-available, where the functional attribute value of the second alternative product is different from that of the target product, or the functional attribute value of the second alternative product is the same as the target functional attribute value and the selling price of the second alternative product is higher than that of the target product.

Before receiving the transaction event information of the alternative product, the method further includes: receiving the transaction selection information, and displaying a transaction selection control in the product transaction system page based on the transaction selection information; and in response to an operation for the transaction of the transaction selection control, sending a transaction request to the server, to trigger the server to perform a transaction based on the second alternative product and send transaction success information of the alternative product.

In some embodiments, the processor 1001 in the computer device 1000 will load instructions corresponding to processes of one or more application programs into the memory 1002 following the steps hereafter, and the processor 1001 runs the application programs stored in the memory 1002, thereby implementing various functions: receiving a product purchase request triggered by a product transaction system page of a target game, where the product purchase request includes target identification information of a target product to be purchased by operating a client; receiving the product purchase request, acquiring the target identification information from the product purchase request, and performing transaction validity verification on the target product based on the target identification information to determine whether the target product is in a transaction-available state in the product transaction system; acquiring target attribute information of the target product if the target product is not in a transaction-available state; selecting a product that meets the purchase intention corresponding to the product purchase request from products in a transaction-available state in the product transaction system as an alternative product, based on the target attribute information; and performing a transaction with the client based on the alternative product.

In some optional embodiments, the selecting a product that meets the purchase intention corresponding to the product purchase request from products in a transaction-available state in the product transaction system as an alternative product, based on the target attribute information includes: selecting a product that matches the target attribute information from products in a transaction-available state in the product transaction system as an alternative product, based on the target attribute information.

In some optional embodiments, the target attribute information may include the target attribute type and the target attribute value, and the selecting a product matching the target attribute information from products in a transaction-available state as an alternative product, based on the target attribute information includes: selecting a product matching the target attribute type from the products in a transaction-available state as a first candidate product, based on the target attribute type; and acquiring the attribute value of the first candidate product, and using the first candidate product of which the difference between the attribute value and the target attribute value is within a preset difference range as an alternative product.

In some optional embodiments, the target attribute value includes a target selling price and a target functional attribute value, the attribute value includes a selling price and a functional attribute value, and the conducting a transaction with the client based on the alternative product includes: determining a first alternative product of which functional attribute values are the same as the target functional attribute values from the alternative products, based on the functional attribute values of the alternative products; and if there is a target alternative product of which the selling price is not higher than the target selling price among the first alternative products, a transaction is performed with the client based on the target alternative product.

In some optional embodiments, the game product transaction method provided by the embodiment of the present disclosure further includes: if there is no target alternative product of which the selling price is not higher than the target selling price among the first alternative products, sending price increase transaction information to the client, to trigger the client to display a price increase transaction selection control based on the price increase transaction information; and receiving a transaction request generated by operating the price increase transaction selection control in the client, and performing a transaction with the client based on the transaction request and the first alternative product.

In some optional embodiments, the target attribute value includes a target quantity and a target associated attribute value, and the attribute value of the first candidate product includes a transaction-available quantity of the first candidate product and an associated attribute value of the first candidate product.

The acquiring the attribute value of the first candidate product, and using the first candidate product of which the difference between the attribute value and the target attribute value is within a preset difference range as an alternative product includes: acquiring the transaction-available quantity of the first candidate product and the associated attribute value of the first candidate product; and using the first candidate product as an alternative product if the associated attribute value of the first candidate product is the same as the target associated attribute value.

The performing a transaction with the client based on the alternative product includes: performing a transaction with the client based on the transaction-available quantity of the alternative product.

In some optional embodiments, the target attribute value includes a target selling price and a target functional attribute value, and the attribute value includes a selling price and a functional attribute value.

The performing a transaction with the client based on the alternative product includes: determining a second alternative product of which the functional attribute value is different from the target functional attribute value, or of which the functional attribute value is the same as the target functional attribute value but the selling price is higher than the target selling price among the alternative products, based on the functional attribute values of the alternative products; determining product difference information between the second alternative product and the target product based on the selling price and functional attribute value of the second alternative product; sending transaction selection information including the product difference information to the client, to trigger the client to display a transaction selection control including the product difference information based on the transaction selection information; and receiving a transaction request generated by operating the transaction selection control in the client, and performing a transaction with the client based on the transaction request and the second alternative product.

In this solution, a product purchase request triggered by a product transaction system page of a target game can be received, the product purchase request includes target identification information of a target product that a client wants to purchase, the target identification information is acquired from the product purchase request, and transaction validity verification is performed on the target product based on the target identification information to determine whether the target product is in a transaction-available state in the product transaction system. If the target product is not in a transaction-available state, target attribute information of the target product is acquired, a product that meets the purchase intention of the client is selected from the products in a transaction-available state in the product transaction system as an alternative product based on the target attribute information, and transactions is performed with the client based on the alternative product. This can reduce the frequency of transaction failures of the game client, improve the efficiency of product transactions performed by the game client, and reduce the background load of game applications.

For the specific implementations of the aforementioned operations, reference can be made to the previous embodiments, which will not be described in detail any more here.

In some embodiments, as shown in FIG. 10, the computer device 1000 further includes: a touch display screen 1003, a radio frequency circuit 1004, an audio circuit 1005, an input unit 1006, and a power supply 1007. The processor 1001 is electrically connected to the touch display screen 1003, the radio frequency circuit 1004, the audio circuit 1005, the input unit 1006, and the power supply 1007, respectively. It can be understood by those skilled in the art that, the structure of the computer device shown in FIG. 10 does not constitute any limitation to the computer device, and may include more or fewer components than those shown in the figure, or may combine some components, or may have different component arrangements.

The touch display screen 1003 can be used for displaying a graphical client interface and receiving operation instructions generated by a client acting on the graphical client interface. The touch display screen 1003 may include a display panel and a touch panel. The display panel may be used for displaying information inputted by the client or information provided to the client, and various graphical client interfaces of the computer device. These graphical client interfaces may be composed of graphics, texts, icons, videos, and any combination thereof. In some embodiments, the display panel may be configured in the form of a Liquid Crystal Display (LCD) or an Organic Light-Emitting Diode (OLED), etc. The touch panel can be used for collecting touch operations performed by the client on or near it (e.g., operations by the client using a finger, stylus, or any other suitable object or accessory on or near the touch panel) and generate corresponding operation instructions which execute the corresponding programs. In some embodiments, the touch panel may include two parts: a touch detection apparatus and a touch controller. The touch detection apparatus detects a touch orientation of the client, detects a signal brought by the touch operation, and transmits the signal to the touch controller. The touch controller receives touch information from the touch detection apparatus, converts the touch information into contact point coordinates, then transmits the contact point coordinates to the processor 1001, can receive a command transmitted from the processor 1001, and can execute the command. The touch panel may cover the display panel. When the touch panel detects a touch operation on or near it, the detected operation is transmitted to the processor 1001 to determine the type of the touch event. Subsequently, the processor 1001 provides the corresponding visual output on the display panel based on the type of the touch event. In the embodiments of the present disclosure, the touch panel and the display panel may be integrated into the touch display screen 1003 to implement input and output functions. However, in some embodiments, the touch panel and the display panel may be implemented as two separate components to perform input and output functions. In some embodiments, the touch display screen 1003 can also function as part of the input unit 1006 to implement the input function.

The radio frequency circuit 1004 can be used for transmitting and receiving a radio frequency signal, so as to establish wireless communication with a network device or other computer devices through wireless communication, and transmit and receive signals between the network device or other computer devices.

The audio circuit 1005 can be used for providing an audio interface between the client and the computer device through a speaker or a microphone. The audio circuit 1005 can transmit an electrical signal converted from received audio data to the speaker, which converts the electrical signal into a sound signal and outputs the sound signal. On the other hand, the microphone converts the collected sound signal into an electrical signal, which is received by the audio circuit 1005, and then converted into audio data. Then, the audio data is outputted to the processor 1001 for processing, and then transmitted to, for example, another computer device through the radio frequency circuit 1004, or the audio data is outputted to the memory 1002 for further processing. The audio circuit 1005 may further include an earphone jack, to provide communication between a peripheral earphone and the computer device.

The input unit 1006 can be used for receiving input numerical or character information or client characteristic information (e.g., fingerprints, iris, facial information, etc.), and generating signal inputs related to client settings and functional controls by means of a keyboard, mouse, joystick, optical device, or trackball.

The power supply 1007 is used for powering various components of the computer device 1000. In some embodiments, the power supply 1007 may be logically connected to the processor 1001 through a power management system, thereby enabling functions such as charging, discharging, and power consumption management to be performed via the power management system. The power supply 1007 may also include one or more direct current or alternating current power supplies, a recharging system, a power failure detection circuit, a power converter or inverter, a power status indicator, or any other components.

Although not shown in FIG. 10, the computer device 1000 may further include a camera, a sensor, a wireless fidelity module, and a Bluetooth module, etc., which will not be described in detail any more here.

In the aforementioned embodiments, each embodiment is described with its own emphasis, and for parts not detailed in a particular embodiment, reference can be made to the relevant descriptions in other embodiments.

As can be seen from the above, the computer device provided in this embodiment can display the product transaction system page of the target game. The product transaction system page includes a product identifier of at least one transaction-available product; generates a product purchase request in response to a purchase operation for a target product; sends the product purchase request to the server, to trigger the server to respond to the product purchase request, selecting an alternative product for transaction when the target product is in a transaction-unavailable state and sending transaction event information of the alternative product; receives the transaction event information of the alternative product, and displays the transaction event information in the product transaction system page, which can reduce the frequency of transaction failures of the game user, improve the efficiency of the game user in product transaction, and reduce the background load of game applications.

It can be understood by those of ordinary skills in the art that all or a part of the steps in the various methods of the aforementioned embodiments can be completed through instructions, or be completed by controlling related hardware through instructions, where the instructions may be stored in a computer-readable storage medium, and loaded and executed by a processor.

To this end, the embodiments of the present disclosure provide a computer-readable storage medium in which multiple computer programs are stored. These computer programs can be loaded by a processor to execute the steps of any one of game product transaction methods provided by the embodiments of the present disclosure. For example, the computer program can execute the following steps: displaying a product transaction system page of a target game, where the product transaction system page includes a product identifier of at least one product available for transaction; generating a product purchase request in response to a purchase operation for a target product; sending the product purchase request to a server, to trigger the server to, in response to the product purchase request, select an alternative product for transaction when the target product is in a transaction-unavailable state and send transaction event information of the alternative product; and receiving the transaction event information of the alternative product and displaying the transaction event information in the product transaction system page.

In some optional embodiments, the sending the product purchase request to a server, to trigger the server to, in response to the product purchase request, select an alternative product for transaction when the target product is in a transaction-unavailable state and send transaction event information of the alternative product includes: sending the product purchase request to a server, to trigger the server to send price increase transaction information when the target product is in a transaction-unavailable state and the selling price of a first alternative product is higher than that of the target product, where the functional attribute value of the first alternative product is the same as the target functional attribute value of the target product.

Before receiving the transaction event information of the alternative product, the method further includes: receiving the price increase transaction information, and displaying a price increase transaction control in the product transaction system page based on the price increase transaction information; and in response to an operation for the transaction of the price increase transaction control, sending a transaction request to the server, to trigger the server to perform a transaction based on the first alternative product and send transaction success information of the alternative product.

The receiving the transaction event information of the alternative product and displaying the transaction event information in the product transaction system page includes: receiving the transaction success information of the alternative product and displaying the transaction success information in the product transaction system page.

In some optional embodiments, the sending the product purchase request to a server, to trigger the server to, in response to the product purchase request, select an alternative product for transaction when the target product is in a transaction-unavailable state and send transaction event information of the alternative product includes: sending the product purchase request to the server, to trigger the server to send transaction selection information when the target product is in a transaction-unavailable state and only a second alternative product is transaction-available, where the functional attribute value of the second alternative product is different from that of the target product, or the functional attribute value of the second alternative product is the same as the target functional attribute value and the selling price of the second alternative product is higher than that of the target product.

Before receiving the transaction event information of the alternative product, the method further includes: receiving the transaction selection information, and displaying a transaction selection control in the product transaction system page based on the transaction selection information; and in response to an operation for the transaction of the transaction selection control, sending a transaction request to the server, to trigger the server to perform a transaction based on the second alternative product and send transaction success information of the alternative product.

In some embodiments, the processor 1001 in the computer device 1000 will load instructions corresponding to processes of one or more application programs into the memory 1002 following the steps hereafter, and the processor 1001 runs the application programs stored in the memory 1002, thereby implementing various functions: receiving a product purchase request triggered by a product transaction system page of a target game, where the product purchase request includes target identification information of a target product to be purchased by operating a client; receiving the product purchase request, acquiring the target identification information from the product purchase request, and performing transaction validity verification on the target product based on the target identification information to determine whether the target product is in a transaction-available state in the product transaction system; acquiring target attribute information of the target product if the target product is not in a transaction-available state; selecting a product that meets the purchase intention corresponding to the product purchase request from products in a transaction-available state in the product transaction system as an alternative product, based on the target attribute information; and performing a transaction with the client based on the alternative product.

In some optional embodiments, the selecting a product that meets the purchase intention corresponding to the product purchase request from products in a transaction-available state in the product transaction system as an alternative product, based on the target attribute information includes: selecting a product that matches the target attribute information from products in a transaction-available state in the product transaction system as an alternative product, based on the target attribute information.

In some optional embodiments, the target attribute information may include the target attribute type and the target attribute value, and the selecting a product matching the target attribute information from products in a transaction-available state as an alternative product, based on the target attribute information includes: selecting a product matching the target attribute type from the products in a transaction-available state as a first candidate product, based on the target attribute type; and acquiring the attribute value of the first candidate product, and using the first candidate product of which the difference between the attribute value and the target attribute value is within a preset difference range as an alternative product.

In some optional embodiments, the target attribute value includes a target selling price and a target functional attribute value, the attribute value includes a selling price and a functional attribute value, and the conducting a transaction with the client based on the alternative product includes: determining a first alternative product of which functional attribute values are the same as the target functional attribute values from the alternative products, based on the functional attribute values of the alternative products; and if there is a target alternative product of which the selling price is not higher than the target selling price among the first alternative products, a transaction is performed with the client based on the target alternative product.

In some optional embodiments, the game product transaction method provided by the embodiment of the present disclosure further includes: if there is no target alternative product of which the selling price is not higher than the target selling price among the first alternative products, sending price increase transaction information to the client, to trigger the client to display a price increase transaction selection control based on the price increase transaction information; and receiving a transaction request generated by operating the price increase transaction selection control in the client, and performing a transaction with the client based on the transaction request and the first alternative product.

In some optional embodiments, the target attribute value includes a target quantity and a target associated attribute value, and the attribute value of the first candidate product includes a transaction-available quantity of the first candidate product and an associated attribute value of the first candidate product.

The acquiring the attribute value of the first candidate product, and using the first candidate product of which the difference between the attribute value and the target attribute value is within a preset difference range as an alternative product includes: acquiring the transaction-available quantity of the first candidate product and the associated attribute value of the first candidate product; and using the first candidate product as an alternative product, if the associated attribute value of the first candidate product is the same as the target associated attribute value, and the transaction-available quantity of the first candidate product is less than the target quantity of the target product.

The performing a transaction with the client based on the alternative product includes: performing a transaction with the client based on the transaction-available quantity of the alternative product.

In some optional embodiments, the target attribute value includes a target selling price and a target functional attribute value, and the attribute value includes a selling price and a functional attribute value.

The performing a transaction with the client based on the alternative product includes: determining a second alternative product of which the functional attribute value is different from the target functional attribute value, or of which the functional attribute value is the same as the target functional attribute value but the selling price is higher than the target selling price among the alternative products, based on the functional attribute values of the alternative products; determining product difference information between the second alternative product and the target product based on the selling price and functional attribute value of the second alternative product; sending transaction selection information including the product difference information to the client, to trigger the client to display a transaction selection control including the product difference information based on the transaction selection information; and receiving a transaction request generated by operating the transaction selection control in the client, and performing a transaction with the client based on the transaction request and the second alternative product.

In the present solution, the product transaction system page of the target game can be displayed. The product transaction system page includes a product identifier of at least one transaction-available product; generates a product purchase request in response to a purchase operation for a target product; sends the product purchase request to the server, to trigger the server to respond to the product purchase request, selecting an alternative product for transaction when the target product is in a transaction-unavailable state and sending transaction event information of the alternative product; receives the transaction event information of the alternative product, and displays the transaction event information in the product transaction system page, which can reduce the frequency of transaction failures of the game user, improve the efficiency of the game user in product transaction, and reduce the background load of game applications.

For the specific implementations of the aforementioned operations, reference can be made to the previous embodiments, which will not be described in detail any more here.

The storage medium may include a read only memory (ROM), random access memory (RAM), a magnetic disk, an optical disk, or the like.

As the computer program stored in the storage medium can execute the steps in any one of the game product transaction methods provided by the embodiments of the present disclosure, it can achieve the beneficial effects that can be achieved by any one of the game product transaction methods provided by the embodiments of the present disclosure. For details, reference can be made to the previous embodiments, which will not be described in detail any more here.

The above has provided a detailed description of the game product transaction method, apparatus and system, the electronic device, and the storage medium provided by the embodiments of the present disclosure. Specific examples are applied herein to elaborate on the principles and implementations of the present disclosure. The descriptions of the above embodiments are merely intended to facilitate understanding of the methods of the present disclosure and core ideas thereof. Meanwhile, for those skilled in the art, changes in specific implementations and application scopes may be made based on the ideas of the present disclosure. In summary, the content of this specification should not be construed as a limitation of the present disclosure.

1. A game product transaction method, comprising:
displaying a product transaction system page of a target game, wherein the product transaction system page comprises a product identifier of a product available for transaction;
generating a product purchase request in response to a purchase operation for a target product;
sending the product purchase request to a server, the server being configured to, in response to the product purchase request, select an alternative product for transaction when the target product is in a transaction-unavailable state and send transaction event information of the alternative product; and
receiving the transaction event information of the alternative product and displaying the transaction event information in the product transaction system page.

2. The game product transaction method according to claim 1, wherein sending the product purchase request to the server, the server being configured to, in response to the product purchase request, select the alternative product for transaction when the target product is in a transaction-unavailable state and send transaction event information of the alternative product comprises:
sending the product purchase request to the server, the server being further configured to send price increase transaction information when the target product is in a transaction-unavailable state and a selling price of a first alternative product is higher than a selling price of the target product, wherein a functional attribute value of the first alternative product is the same as a functional attribute value of the target product;
before receiving the transaction event information of the alternative product, the method further comprises:
receiving the price increase transaction information, and displaying a price increase transaction control in the product transaction system page based on the price increase transaction information; and
in response to an operation to perform a transaction via the price increase transaction control, sending a transaction request to the server, the server being configured to perform a transaction based on the first alternative product and to send transaction success information of the first alternative product, and
receiving the transaction event information of the alternative product and displaying the transaction event information in the product transaction system page comprises:
receiving the transaction success information of the first alternative product and displaying the transaction success information in the product transaction system page.

3. The game product transaction method according to claim 1, wherein sending the product purchase request to the server, the server being configured to, in response to the product purchase request, select the alternative product for transaction when the target product is in a transaction-unavailable state and send transaction event information of the alternative product comprises:
sending the product purchase request to the server, the server being further configured to send transaction selection information when the target product is in a transaction-unavailable state and only a second alternative product is transaction-available, wherein a functional attribute value of the second alternative product is different from a functional attribute value of the target product, or a functional attribute value of the second alternative product is the same as a functional attribute value of the target product and a selling price of the second alternative product is higher than a selling price of the target product, and
before receiving the transaction event information of the alternative product, the method further comprises:
receiving the transaction selection information, and displaying a transaction selection control in the product transaction system page based on the transaction selection information; and
in response to an operation to perform a transaction via the transaction selection control, sending a transaction request to the server, to the server being configured to perform a transaction based on the second alternative product and to send transaction success information of the second alternative product.

4. A game product transaction method, comprising:
receiving a product purchase request triggered by a client of a target game, wherein the product purchase request comprises target identification information of a target product intended for purchase via operation of the client;
acquiring the target identification information from the product purchase request, and performing transaction validity verification on the target product based on the target identification information to determine whether the target product is in a transaction-available state in a product transaction system;
acquiring target attribute information of the target product when the target product is not in a transaction-available state;
selecting, based on the target attribute information, an alternative product request from products in a transaction-available state in the product transaction system, the alternative product meeting a purchase intention corresponding to the product purchase request; and
performing a transaction with the client based on the alternative product.

5. The game product transaction method according to claim 4, wherein selecting, based on the target attribute information, the alternative product from products in a transaction-available state in the product transaction system comprises:
selecting, from the products in a transaction-available state in the product transaction system, the alternative product that matches the target attribute information.

6. The game product transaction method according to claim 5, wherein the target attribute information comprises a target attribute type and a target attribute value; and
selecting, from the products in a transaction-available state, the alternative product that matches the target attribute information comprises:
selecting, from the products in the transaction-available state, a first candidate product having an attribute type that matches the target attribute type; and
acquiring an attribute value of the first candidate product, and selecting the first candidate product as the alternative product when a difference between the attribute value of the first candidate product and the target attribute value is within a preset difference range.

7. The game product transaction method according to claim 6, wherein the target attribute value comprises a target selling price and a target functional attribute value, the attribute value of the first candidate product comprises a selling price and a functional attribute value, and
performing the transaction with the client based on the alternative product comprises:
determining a first alternative product from the alternative products, the first alternative product having a functional attribute value that is the same as the target functional attribute value; and
when a selling price of a target alternative product is not higher than the target selling price among the first alternative products, performing a transaction with the client based on the target alternative product.

8. The game product transaction method according to claim 7, further comprising:
when there is no target alternative product, among the first alternative products, having a selling price that is not higher than the target selling price, sending price increase transaction information to the client, the client being configured to display a price increase transaction selection control based on the price increase transaction information; and
receiving, from a client, a transaction request generated in response to operation of the price increase transaction selection control, and performing a transaction with the client based on the transaction request and the first alternative product.

9. The game product transaction method according to claim 6, wherein the target attribute value comprises a target quantity and a target associated attribute value, and the attribute value of the first candidate product comprises a transaction-available quantity of the first candidate product and an associated attribute value of the first candidate product,
acquiring the attribute value of the first candidate product, and selecting the first candidate product as the alternative product when the difference between the attribute value of the first candidate product and the target attribute value is within the preset difference range comprises:
acquiring the transaction-available quantity of the first candidate product and the associated attribute value of the first candidate product; and
selecting the first candidate product as the alternative product when the associated attribute value of the first candidate product is the same as the target associated attribute value, and
performing the transaction with the client based on the alternative product comprises:
performing the transaction with the client based on the transaction-available quantity of the alternative product.

10. The game product transaction method according to claim 6, wherein the target attribute value comprises a target selling price and a target functional attribute value, and the attribute value of the first candidate product comprises a selling price and a functional attribute value and
performing the transaction with the client based on the alternative product comprises:
determining a second alternative product from the alternative products, the second alternative product having a functional attribute value that is different from the target functional attribute value, or a functional attribute value that is the same as the target functional attribute value but a selling price is higher than the target selling price;
determining product difference information between the second alternative product and the target product based on the selling price and the functional attribute value of the second alternative product;
sending transaction selection information comprising the product difference information to the client, the client being configured to display a transaction selection control comprising the product difference information based on the transaction selection information; and
receiving, from the client, a transaction request generated in response to operation of the transaction selection control, and performing the transaction with the client based on the transaction request and the second alternative product.

11. A game product transaction method, comprising:
displaying, by a client of a target game, a product transaction system page, wherein the product transaction system page comprises a product identifier of a product available for transaction;
generating, by the client, a product purchase request in response to a purchase operation for a target product, and sending the product purchase request to a server of the target game, wherein the product purchase request comprises target identification information of the target product intended for purchase via operation of the client;
receiving, by the server, the product purchase request, acquiring the target identification information from the product purchase request, and performing transaction validity verification on the target product based on the target identification information to determine whether the target product is in a transaction-available state in the product transaction system;
acquiring, by the server, target attribute information of the target product when the target product is not in a transaction-available state, and selecting, based on the target attribute information, an alternative product from products in a transaction-available state in the product transaction system, the alternative product satisfying a purchase intention corresponding to the purchase request;
performing, by the server, a transaction with the client based on the alternative product, and sending transaction event information of the alternative product to the client; and
receiving, by the client, the transaction event information of the alternative product, and displaying the transaction event information in the product transaction system page.

12-14. (canceled)

15. A system, comprising:
one or more memories collectively containing one or more programs; and
one or more processors, wherein the one or more processors are configured to, individually or collectively, perform an operation comprising:
displaying a product transaction system page of a target game, wherein the product transaction system page comprises a product identifier of a product available for transaction;
generating a product purchase request in response to a purchase operation for a target product;
sending the product purchase request to a server, the server being configured to, in response to the product purchase request, select an alternative product for transaction when the target product is in a transaction-unavailable state and send transaction event information of the alternative product; and
receiving the transaction event information of the alternative product and displaying the transaction event information in the product transaction system page.

16. One or more non-transitory computer-readable storage media containing, in any combination, computer program code that, when executable by a computer system, perform an operation comprising:
displaying a product transaction system page of a target game, wherein the product transaction system page comprises a product identifier of a product available for transaction;
generating a product purchase request in response to a purchase operation for a target product;
sending the product purchase request to a server, the server being configured to, in response to the product purchase request, select an alternative product for transaction when the target product is in a transaction-unavailable state and send transaction event information of the alternative product; and
receiving the transaction event information of the alternative product and displaying the transaction event information in the product transaction system page.

17. A system, comprising:
one or more memories collectively containing one or more programs; and
one or more processors, wherein the one or more processors are configured to, individually or collectively, perform an operation comprising:
receiving a product purchase request triggered by a client of a target game, wherein the product purchase request comprises target identification information of a target product intended for purchase via operation of the client;
acquiring the target identification information from the product purchase request, and performing transaction validity verification on the target product based on the target identification information to determine whether the target product is in a transaction-available state in a product transaction system;
acquiring target attribute information of the target product when the target product is not in a transaction-available state;
selecting, based on the target attribute information, an alternative product from products in a transaction-available state in the product transaction system, the alternative product meeting a purchase intention corresponding to the product purchase request; and
performing a transaction with the client based on the alternative product.

18. One or more non-transitory computer-readable storage media containing, in any combination, computer program code that, when executable by a computer system, perform an operation comprising:
receiving a product purchase request triggered by a client of a target game, wherein the product purchase request comprises target identification information of a target product intended for purchase via operation of the client;
acquiring the target identification information from the product purchase request, and performing transaction validity verification on the target product based on the target identification information to determine whether the target product is in a transaction-available state in a product transaction system;
acquiring target attribute information of the target product when the target product is not in a transaction-available state;
selecting, based on the target attribute information, an alternative product from products in a transaction-available state in the product transaction system, the alternative product meeting a purchase intention corresponding to the product purchase request; and
performing a transaction with the client based on the alternative product.

19. The system according to claim 15, wherein sending the product purchase request to the server, the server being configured to, in response to the product purchase request, select the alternative product for transaction when the target product is in a transaction-unavailable state and send transaction event information of the alternative product comprises:
sending the product purchase request to the server, the server being further configured to send price increase transaction information when the target product is in a transaction-unavailable state and a selling price of a first alternative product is higher than a selling price of the target product, wherein a functional attribute value of the first alternative product is the same as a functional attribute value of the target product,
before receiving the transaction event information of the alternative product, the operation further comprises:
receiving the price increase transaction information, and displaying a price increase transaction control in the product transaction system page based on the price increase transaction information; and
in response to an operation to perform a transaction via the price increase transaction control, sending a transaction request to the server, the server being configured to perform a transaction based on the first alternative product and to send transaction success information of the first alternative product, and
receiving the transaction event information of the alternative product and displaying the transaction event information in the product transaction system page comprises:
receiving the transaction success information of the first alternative product and displaying the transaction success information in the product transaction system page.

20. The system according to claim 15, wherein sending the product purchase request to the server, the server being configured to, in response to the product purchase request, select the alternative product for transaction when the target product is in a transaction-unavailable state and send transaction event information of the alternative product comprises:
sending the product purchase request to the server, the server being further configured to send transaction selection information when the target product is in a transaction-unavailable state and only a second alternative product is transaction-available, wherein a functional attribute value of the second alternative product is different from a functional attribute value of the target product, or a functional attribute value of the second alternative product is the same as a functional attribute value of the target product and a selling price of the second alternative product is higher than a selling price of the target product, and
before receiving the transaction event information of the alternative product, the operation further comprises:
receiving the transaction selection information, and displaying a transaction selection control in the product transaction system page based on the transaction selection information; and
in response to an operation to perform a transaction via the transaction selection control, sending a transaction request to the server, the server being configured to perform a transaction based on the second alternative product and to send transaction success information of the second alternative product.

21. The system according to claim 17, wherein selecting, based on the target attribute information, the alternative product from products in a transaction-available state in the product transaction system comprises:
selecting, from the products in a transaction-available state in the product transaction system, the alternative product that matches the target attribute information.

22. The system according to claim 21, wherein the target attribute information comprises a target attribute type and a target attribute value; and
selecting, from the products in a transaction-available state, the alternative product that matches the target attribute information comprises:
selecting, from the products in the transaction-available state, a first candidate product having an attribute type that matches the target attribute type; and
acquiring an attribute value of the first candidate product, and selecting the first candidate product as the alternative product when a difference between the attribute value of the first candidate product and the target attribute value is within a preset difference range.

23. The system according to claim 22, wherein the target attribute value comprises a target selling price and a target functional attribute value, the attribute value of the first candidate product comprises a selling price and a functional attribute value, and
performing the transaction with the client based on the alternative product comprises:
determining a first alternative product from the alternative products, the first alternative product having a functional attribute value that is the same as the target functional attribute value; and
when a selling price of a target alternative product is not higher than the target selling price among the first alternative products, performing a transaction with the client based on the target alternative product.
